(19) United States
(12) Patent Application Publication
(10) Pub. No.: US 2022/0227948 A1
(43) Pub. Date: Jul. 21, 2022

(54) RESIN COMPOSITION PRODUCTION METHOD AND RESIN COMPOSITION

(71) Applicant: SEIKO PMC CORPORATION, Tokyo (JP)

(72) Inventors: Yuya TERAO, Chiba (JP); Takashi KAWABATA, Chiba (JP); Takayuki TSUNODA, Chiba (JP); Takafumi SEKIGUCHI, Chiba (JP)

(73) Assignee: SEIKO PMC CORPORATION, Tokyo (JP)

(21) Appl. No.: 17/611,907

(22) PCT Filed: Apr. 27, 2020
(86) PCT No.: PCT/JP2020/017928

§ 371 Date: Nov. 16, 2021

(30) Foreign Application Priority Data
May 21, 2019 (JP) 2019-095273

(51) Int. Cl. C08J 5/04; C08K 7/02; C08L 33/08; C08L 25/14; C08L 23/12; B29C 48/00; B29C 48/40

(52) U.S. Cl. CPC C08J 5/045; C08K 7/02; C08L 33/08; B29C 48/40; C08L 23/12; B29C 48/022; C08L 25/14

(57) ABSTRACT

The resin composition production method includes a step in which a cellulose fiber composition containing 5 to 45 parts by mass of water with respect to a total of 100 parts by mass of cellulose fibers (A) and an acrylic resin and/or a styrene acrylic resin (B) is kneaded with a thermoplastic resin (C), and water is removed until the water content after kneading falls to 1% or less. The resin composition production method is also characterized in that: 20 parts by mass or more and 200 parts by mass or less of the resin (B) is blended with respect to 100 parts by mass of the cellulose fibers (A), the dissolution amount of the resin (B) in 100 g of water at 25° C. is less than 1 g, and the glass transition temperature of the resin (B) is 40 to 150° C.

### TECHNICAL FIELD

The present invention relates to a resin composition production method which is capable of improving the strength of a cellulose fiber composite resin molded body, and relates to a resin composition.

### RELATED ART

Conventionally, fibrous additives such as glass fibers, carbon fibers, aramid fibers, cellulose fibers, and the like have been used for the purpose of improving the strength of a resin molded body. Among the above fibrous additives, the cellulose fibers have features such as a low density, a high elastic modulus, a low coefficient of linear thermal expansion, and the like. In addition, the cellulose fibers are “carbon neutral” and are sustainable resources, and thus are expected to be a material that contributes to reducing the environmental burden. However, the strength of the cellulose fibers is not sufficiently reflected in the molded body probably because the cellulose fibers are hydrophilic, the resin is hydrophobic, and the adhesiveness between the cellulose fibers and the resin is poor. In addition, because it is difficult to highly disperse the cellulose fibers in the resin, there is a case in which a sufficient reinforcing effect on the molded body is not obtained.

Various compositions and methods have been proposed as measures for sufficiently exerting the effect of adding the cellulose fibers, that is, the strength, in a cellulose fiber composite resin.

For example, Patent literature 1 indicates that a cellulose fiber composite resin composition containing a polymer having a (meth)acrylamide and a (meth)acrylic acid ester improves the strength of a molded body. In addition, Patent literature 2 indicates that a resin composition is excellent in defibration properties of pulp and can impart excellent mechanical strength to a molded article, the resin composition taking a specific alkyl (meth)acrylate and an amide-group-containing acrylic monomer as essential raw materials and containing an acrylic resin that has a specific weight average molecular weight. However, when cellulose fibers are used for a thermoplastic resin, particularly a polyolefin, the dispersion effect of the cellulose fibers is not sufficient, and the reinforcing effect brought by the cellulose fibers is not satisfactory in the mechanical strength of the molded article, either.

Patent literature 3 indicates that by adding, to a cellulose fiber resin composition containing cellulose fibers and a polyolefin, a polymer obtained in way that a hydrophilic macromolecule and/or an acidic group is bonded to a polyolefin, the affinity between the cellulose fibers and the resin can be improved and the blending effect (dimensional stability) of the cellulose fibers can be sufficiently exerted. However, the mechanical strength of a molded article is not indicated, and actually, the reinforcing effect is not satisfactory, either.

### LITERATURE OF RELATED ART

### [Patent Literature]

Patent literature 1: International Publication No. 2015/163405
Patent literature 2: Japanese Patent Laid-Open No. 2018-104533
Patent literature 3: Japanese Patent Laid-Open No. 2009-167249

### SUMMARY

### Problems to be Solved

In this regard, the present invention addresses the problem of providing a resin composition production method which is capable of drastically improving the strength of a molded body that uses a resin composition containing cellulose fibers, and the problem of providing a resin composition.

### Means to Solve Problems

As a result of intensive studies to solve the above problems, the inventors found that a resin composition is excellent in mechanical strength, the resin composition containing cellulose fibers, an acrylic resin and/or a styrene acrylic resin which have/has a specific dissolution amount in water and a specific glass transition temperature, and a thermoplastic resin.

That is, measures of the present invention for solving the above problems are as follows:

<1> A resin composition production method including a step in which a cellulose fiber composition containing 5 to 45 parts by mass of water with respect to a total of 100 parts by mass of cellulose fibers (A) and an acrylic resin and/or a styrene acrylic resin (B) is kneaded with a thermoplastic resin (C), and water is removed until the water content after kneading falls to 1% or less, wherein 20 parts by mass or more and 200 parts by mass or less of the acrylic resin and/or the styrene acrylic resin (B) is blended with respect to 100 parts by mass of the cellulose fibers (A); and the dissolution amount of the acrylic resin and/or the styrene acrylic resin (B) in 100 g of water at 25° C. is less than 1 g, and the glass transition temperature of the acrylic resin and/or the styrene acrylic resin (B) is 40 to 150° C.
<2> The resin composition production method according to the above <1>, wherein the acrylic resin and/or the styrene acrylic resin (B) is a polymer of a monomer containing an acrylic acid and/or a methacrylic acid and has an acid value of 10 to 200 mgKOH/g.
<3> The resin composition production method according to the above <1>, wherein the mass ratio of the total of the cellulose fibers (A) and the acrylic resin and/or the styrene acrylic resin (B) to the thermoplastic resin (C) is [(A)+(B)]/(C)=1/99 to 60/40.
<4> The resin composition production method according to the above <1>, wherein the thermoplastic resin (C) is a polyolefin.
<5> A resin composition containing: cellulose fibers (A), an acrylic resin and/or a styrene acrylic resin (B), and a thermoplastic resin (C), wherein the resin composition contains, with respect to 100 parts by mass of the cellulose fibers (A), 20 parts by mass or more and 200 parts by mass or less of the acrylic resin and/or the styrene acrylic resin (B), the dissolution amount of the acrylic resin and/or the styrene acrylic resin (B) in 100 g of water at 25° C. is less than 1 g, and the glass transition temperature of the acrylic resin and/or the styrene acrylic resin (B) is 40 to 150° C.
<6> The resin composition according to the above <5>, wherein the acrylic resin and/or the styrene acrylic resin (B) is a polymer of a monomer containing an acrylic acid and/or a methacrylic acid and has an acid value of 10 to 200 mgKOH/g.
<7> The resin composition according to the above <5>, wherein the mass ratio of the total of the cellulose fibers (A) and the acrylic resin and/or the styrene acrylic resin (B) to the thermoplastic resin (C) is [(A)+(B)]/(C)=1/99 to 60/40.
<8> The resin composition according to the above <5>, wherein the thermoplastic resin (C) is a polyolefin.

### Effect

According to the resin composition production method of the present invention, or by using the resin composition of the present invention, the strength of the molded body of the obtained resin composition can be drastically improved.

### DESCRIPTION OF THE EMBODIMENTS

Hereinafter, embodiments of the present invention are described in detail. Note that, the following description is an example of the embodiments of the present invention, and the present invention is not limited to the description.

<Raw Material of Resin Composition>

A resin composition of the present invention at least takes cellulose fibers (A), an acrylic resin and/or a styrene acrylic resin (B), and a thermoplastic resin (C) as raw materials.

The cellulous fibers (A) are derived from a plant (for example, wood, bamboo, hemp, jute, kenaf, agricultural waste, cloth, pulp (nadelholz unbleached kraft pulp (NUKP), nadelholz bleached kraft pulp (NBKP), laubholz unbleached kraft pulp (LUKP), laubholz bleached kraft pulp (LBKP), nadelholz unbleached sulphite pulp (NUSP), nadelholz bleached sulphite pulp (NBSP), thermomechanical pulp (TMP), recycled pulp, used paper, and the like), an animal (for example, ascidians), algae, a microorganism (for example, acetic acid bacteria (acetobacter)), a microbial product, and the like, any one of which can be used in the present invention. The cellulosic fibers derived from a plant or a microorganism are preferable, and the cellulose fibers derived from a plant are more preferable. Among the cellulose fibers derived from a plant, pulp (particularly nadelholz unbleached kraft pulp (NUKP), nadelholz bleached kraft pulp (NBKP)) is particularly preferable. In addition, the raw material cellulose fibers may be modified cellulose in which the functional group of cellulose is substituted and modified. For example, the raw material cellulose fibers may be modified cellulose fibers which are obtained by esterifying the hydroxyl group of cellulose with, for example, carboxylic anhydride such as maleic anhydride, acetic anhydride, alkenyl succinic anhydride and the like.

The acrylic resin and/or the styrene acrylic resin (B) is a polymer or copolymer of an acrylic monomer, or a copolymer of an acrylic monomer and a styrene monomer and a mixture thereof.

The acrylic monomer refers to (meth)acrylic acid and derivatives thereof, and specifically, the acrylic monomer may be: a monomer containing a linear saturated alkyl group, such as methyl (meth)acrylate, ethyl (meth)acrylate, propyl (meth)acrylate, butyl (meth)acrylate, hexyl (meth)acrylate, nonyl (meth)acrylate, dodecyl (meth)acrylate, tridecyl (meth)acrylate, tetradecyl (meth)acrylate, hexadecyl (meth)acrylate, and stearyl (meth)acrylate; a monomer containing a branched saturated alkyl group, such as isopropyl (meth)acrylate, isobutyl (meth)acrylate, t-butyl (meth)acrylate, and 2-ethylhexyl (meth)acrylate; an alicyclic alkyl-group-containing monomer, such as cyclohexyl (meth)acrylate, t-butylcyclohexyl (meth)acrylate, and isobornyl (meth)acrylate; an aromatic-containing monomer, such as phenyl (meth)acrylate and benzyl (meth)acrylate; unsaturated carboxylic acids, such as acrylic acid, methacrylic acid, and 2-methacryloyloxyethyl succinic acid; a (meta)acrylate having a functional group, such as 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, and ethoxydiethylene glycol (meth)acrylate; and (meth)acrylamides such as (meth)acrylamide, N-isopropyl (meth)acrylamide, N,N-dimethyl (meth)acrylamide, N,N-diethyl (meth)acrylamide, (meth)acryloylmorpholine, diacetone acrylamide, N-methylol acrylamide, and N-hydroxyethyl acrylamide. Among these, methyl (meth)acrylate, butyl (meth)acrylate, dodecyl (meth)acrylate, tridecyl (meth)acrylate, isobutyl (meth)acrylate, t-butyl (meth)acrylate, 2-ethylhexyl (meth)acrylate, cyclohexyl (meth)acrylate, and benzyl (meth)acrylate are preferable. In addition, from the viewpoint of improving the affinity with cellulose, it is preferable to use an acrylic acid and a methacrylic acid to the extent of having a suitable acid value as described later.

The styrene monomer refers to styrene and derivatives thereof, and specifically, the styrene monomer may be: styrene, α-methylstyrene, divinylbenzene, 4-methylstyrene, 4-t-butylstyrene, 4-n-octylstyrene, sodium styrene sulfonate, 4-vinylbenzoic acid, 4-aminostyrene, 4-methoxystyrene, 4-nitrostyrene, stilbene, 4,4′-dimethyl-stilbene, and the like. Among these, styrene and α-methylstyrene are particularly preferable.

From the viewpoint of the dispersibility of the cellulose fibers (A) in the thermoplastic resin (C) and the reinforcing effect of the resin composition, the ratio of the acrylic monomer and the styrene monomer, which are the main components of the monomers constituting the acrylic resin and/or the styrene acrylic resin (B), is preferably 70 to 100 parts by mass of the entire acrylic resin and/or styrene acrylic resin (B).

In addition, an ethylenically unsaturated compound other than the above acrylic monomer and styrene monomer can also be used in a range in which the effect of the present invention is not impaired. Specifically, the ethylenically unsaturated compound may be: an unsaturated dibasic acid such as fumaric acid, maleic acid, maleic anhydride, and itaconic acid; a monoesterified product and a diesterified product of an unsaturated dibasic acid and methanol, ethanol, n-propanol, i-propanol, n-butanol, i-butanol, 2-butanol, t-butanol, cyclohexanol, 2-ethylhexanol, n-octanol, n-dodecyl alcohol, n-octadecyl alcohol, and the like; a vinyl ester such as vinyl acetate and vinyl propionate; and vinyl ethers such as isobutyl vinyl ether, dodecyl vinyl ether, cyclohexyl vinyl ether, diethylene glycol monovinyl ether, and 4-hydroxybutyl vinyl ether.

The method for polymerizing the acrylic resin and/or the styrene acrylic resin (B) is not limited, and conventionally known methods such as solution polymerization, suspension polymerization, emulsion polymerization, solvent-free bulk polymerization and the like can be used. The reaction mechanism is not particularly limited either, and radical polymerization, anionic polymerization, cationic polymerization, coordination polymerization, various types of living polymerization and the like can be used. As the polymerization initiator and the polymerization solvent used here, conventionally known compounds can be used.

The acrylic resin and/or the styrene acrylic resin (B) may be a graft product obtained by grafting the acrylic monomer or the acrylic monomer and the styrene monomer onto a polyolefin. The polyolefin may be a homopolymer such as polyethylene, polypropylene and the like, or may be a copolymer of olefin, but a copolymer of α-olefin containing at least ethylene and/or propylene is desirable. The α-olefin may be: ethylene, propylene, 1-butene, 1-pentene, 1-hexene, 1-heptene, 1-octene, 1-nonene, 1-decene, 1-dodecene, 1-dodecadecene, 4-methyl-1-pentene, and the like. The copolymer may be a random copolymer, a block copolymer, a graft copolymer, and a mixture thereof. The method of grafting the acrylic monomer or the acrylic monomer and the styrene monomer onto the polyolefin can be performed by a known method, for example, a solution method in which the polyolefin is dissolved or uniformly dispersed in an organic solvent by setting the temperature to a temperature equal to or higher than the softening point, and the acrylic monomer or the styrene monomer and an organic peroxide are added and made to react; and a melting method in which the polyolefin is melted by being made to the softening point or higher, and the acrylic monomer or the styrene monomer and an organic peroxide are added, mixed, and made to react.

The dissolution amount of the acrylic resin and/or the styrene acrylic resin (B) in 100 g of water at 25° C. is required to be less than 1 g. When the dissolution amount in 100 g of water at 25° C. is 1 g or more, the cellulose fibers (A) aggregate, and thus the dispersibility in the thermoplastic resin (C) deteriorates. A dissolution amount of less than 0.5 g in 100 g of water at 25° C. is preferable because the compatibility with the thermoplastic resin (C) is further improved.

The glass transition temperature of the acrylic resin and/or the styrene acrylic resin (B) is required to be 40 to 150° C. When the glass transition temperature is less than 40° C., the strength of a molded body using the resin composition is reduced due to the plasticization effect of the acrylic resin and/or the styrene acrylic resin (B). In addition, when the acrylic resin and/or the styrene acrylic resin (B) is kneaded together with the cellulose fibers (A) and the thermoplastic resin (C), a shearing force generated along with kneading is not sufficiently obtained, and the cellulose fibers (A) are not well dispersed. Furthermore, after the resin composition is made into a molded body, the acrylic resin and/or the styrene acrylic resin (B) may bleed out from the inside of the molded body, and inconvenience such as contamination of the surface of the molded body may be caused. In a case that the glass transition temperature is higher than 150° C., the shearing force generated along with kneading is too strong when the kneading together with the cellulose fibers (A) and the thermoplastic resin (C) is performed, and thus the cellulose fibers (A) may become short fibers, and the reinforcing effect of the molded body using the resin composition, which is brought by the entanglement of the cellulose fibers (A), may be weakened.

From the viewpoint of improving the affinity with the cellulose fibers (A), the acid value of the acrylic resin and/or the styrene acrylic resin (B) is preferably 10 to 200 mgKOH/g. When the acid value is smaller than 10 mgKOH/g, the cellulose fibers (A) may aggregate and may not be well dispersed in the thermoplastic resin (C). When the acid value is greater than 200 mgKOH/g, the cellulose fibers (A) may become short fibers due to the acid, and the reinforcing effect of the molded body using the resin composition, which is brought by the entanglement of the cellulose fibers (A), may be weakened. A case that the acid value is 50 to 200 mgKOH/g is more preferable because the dispersibility of the cellulose fibers (A) is further improved in this case.

From the viewpoint of the dispersibility of the cellulose fibers (A) in the thermoplastic resin (C) and the reinforcing effect of the resin composition, the number average molecular weight of the acrylic resin and/or the styrene acrylic resin (B), which is measured by gel permeation chromatography, is preferably 3,000 to 1,000,000 and more preferably 3,000 to 100,000 in terms of polystyrene. It should be noted that the number average molecular weight referred to in the present invention is measured by the following device and conditions.

Device: Gel Permeation Chromatography (HLC-8320GPC) manufactured by Tosoh Corporation

Column: TSKgel SuperMultipore HZ-H and TSKgel SuperMultipore HZ-M are sequentially connected in series for use.

Developing solvent: tetrahydrofuran

Detector: RI (differential refractive index) detector

Sample: tetrahydrofuran 10 mL solution of 0.01 g of acrylic resins or styrene acrylic resins (B-1 to BH-2)

The thermoplastic resin (C) is not particularly limited as long as it is a resin generally used for a molded body other than the acrylic resin and/or the styrene acrylic resin (B). The thermoplastic resin (C) may be, for example, a polyolefin such as polyethylene, polypropylene, and ethylene-propylene copolymer; a polyamide resin such as a polyacetal resin and nylon; a polyester resin such as polyethylene terephthalate and polybutylene terephthalate; a chlorine resin such as polyvinyl chloride and polyvinylidene chloride; a fluororesin such as polyvinyl fluoride and polyvinylidene fluoride; a thermoplastic elastomer such as olefin elastomer, vinyl chloride elastomer, urethane elastomer, polyester elastomer, and polyamide elastomer; an ionomer resin, polyacrylonitrile, an ethylene-vinyl acetate resin, an ethylene-vinyl alcohol resin, a polycarbonate resin, a modified polyphenylene ether resin, a methylpentene resin, and the like. A thermoplastic resin having a melting point or a softening point of 220° C. or lower is preferable because the influence of heat on the cellulose fibers is small in this case. Specifically, it is suitable to use polyolefin.

<Method for Producing Resin Composition>

A resin composition production method of the present invention has a step in which a cellulose fiber composition containing 5 to 45 parts by mass of water with respect to a total of 100 parts by mass of the cellulose fibers (A) and the acrylic resin and/or the styrene acrylic resin (B) is kneaded with the thermoplastic resin (C), and water is removed until the water content after kneading falls to 1% or less.

In the present invention, when the cellulose fibers (A), the acrylic resin and/or the styrene acrylic resin (B), and the thermoplastic resin (C) are kneaded, a cellulose fiber composition, in which the cellulose fibers (A) and the acrylic resin and/or the styrene acrylic resin (B) are mixed, is preferably obtained in advance in order to obtain a uniform resin composition. As long as the cellulose fibers (A) and the acrylic resin and/or the styrene acrylic resin (B) can be uniformly mixed, the mixing method is not particularly limited. The acrylic resin and/or the styrene acrylic resin (B) may be added in a solid state to the cellulose fibers (A), but from the viewpoint of uniformly mixing the cellulose fibers (A) and the acrylic resin and/or the styrene acrylic resin (B), it is preferable to use water, an organic solvent or the like to mix the acrylic resin and/or the styrene acrylic resin (B) with the cellulose fibers (A). The mixture solvent is not particularly limited, and conventionally known compounds can be used. At the time of mixing, a filler, a cross-linking agent, or the like may be mixed in addition to the cellulose fibers (A).

The composition containing the cellulose fibers (A) and the acrylic resin and/or the styrene acrylic resin (B) may be dried or used with the solvent contained therein, but a dried composition is preferable. In the case of drying, the drying method is not particularly limited, and it is sufficient if the drying can be performed at a temperature that does not cause aggregation or decomposition of the cellulose fibers (A) or the acrylic resin and/or the styrene acrylic resin (B). In order to suppress the shrinkage of the composition containing the cellulose fibers (A) and the acrylic resin and/or the styrene acrylic resin (B) at the time of drying, it is preferable to dynamically dry the contents under a reduced-pressure atmosphere while stirring the contents.

Next, a water-containing cellulose fiber composition containing 5 to 45 parts by mass of water with respect to a total of 100 parts by mass of the cellulose fibers (A) and the acrylic resin and/or the styrene acrylic resin (B) is obtained. When the water content is less than 5 parts by mass, the effect of the present invention cannot be obtained, and when the water content is more than 45 parts by mass, it becomes difficult to remove the water during the kneading with the thermoplastic resin (C).

Subsequently, when the water-containing cellulose fiber composition and the thermoplastic resin (C) are kneaded, the cellulose fibers (A) are dispersed and water is removed until the water content after kneading falls to 1% or less so as to obtain the resin composition of the present invention. The kneader may be either a batch type kneader or a continuous type kneader, and preferably has equipment capable of removing water, a vent hole, or the like.

The temperature at the time of kneading is preferably a temperature at which water in the resin composition can be removed and the cellulose fibers are not deteriorated due to heat. Specifically, kneading is preferably performed in a range of 100 to 250° C.

Water in the obtained resin composition is required to be removed to 1% or less during kneading. When water remains in the final composition, deterioration in quality such as coloring over time is easily caused.

With regard to the ratio of the acrylic resin and/or the styrene acrylic resin (B) to the cellulose fibers (A), 20 parts by mass or more and 200 parts by mass or less of the acrylic resin and/or the styrene acrylic resin (B) is required to be contained in 100 parts by mass of the cellulose fibers (A). When the amount of the acrylic resin and/or the styrene acrylic resin (B) is less than 20 parts by mass with respect to 100 parts by mass of the cellulose fibers (A), the cellulose fibers (A) cannot be uniformly dispersed in the resin composition, and as a result, it becomes difficult to obtain the strength of the molded body using the resin composition. In addition, when the amount of the acrylic resin and/or the styrene acrylic resin (B) is more than 200 parts by mass with respect to 100 parts by mass of the cellulose fibers (A), the surplus component (B) is released in the molded body and acts as a plasticizer, thus making it difficult to obtain the strength of the molded body using the resin composition.

<Resin Composition>

In the resin composition of the present invention, the mass ratio of the total of the cellulose fibers (A) and the acrylic resin and/or the styrene acrylic resin (B) to the thermoplastic resin (C) is preferably [(A)+(B)]/(C)=1/99 to 60/40, and more preferably 15/85 to 40/60. When the total of the cellulose fibers (A) and the acrylic resin and/or the styrene acrylic resin (B) is less than 1, the reinforcing effect of the resin composition may not be sufficiently obtained. When the total of the cellulose fibers (A) and the acrylic resin and/or the styrene acrylic resin (B) is more than 60, the melt viscosity of the resin composition may become too high, and inconvenience in moldability may be caused.

In a range in which the effect of the present invention is not impaired, maleic anhydride-modified polyolefin, a resin other than the thermoplastic resin (C), various fillers such as talc, clay and glass fibers, a crystallization nucleating agent, a cross-linking agent, a hydrolysis inhibitor, an antioxidant, a lubricant, wax, a colorant, a stabilizer, and the like may be blended in the resin composition of the present invention.

<Molded Body>

In order to make the resin composition obtained in the above manner into a molded body, a general molding method can be used. The general molding method may be, for example, injection molding, extrusion molding, blow molding, compression molding, foam molding, or the like.

In addition, the usage of the molded body using the resin composition of the present invention is not particularly limited and may be, for example, an interior/exterior material, a housing, or the like for a transportation machine such as an automobile, a motorcycle, a bicycle, a railroad, a drone, a rocket, an aircraft, and a ship; an energy machine such as a wind generator and a hydraulic generator; a housing of a home appliance such as an air conditioner, a refrigerator, a vacuum cleaner, a microwave oven, audiovisual (AV) equipment, a digital camera, and a personal computer; a housing of communication equipment such as an electronic substrate, a mobile phone, and a smartphone; a medical instrument such as a crutch and a wheelchair; shoes such as sneakers and business shoes; a tire; sporting goods such as a ball for ball sports, ski boots, a snowboard, a golf club, a protector, a fishing thread, and an artificial bait; outdoor goods such as a tent and a hammock; a civil engineering and construction material such as an electric wire coating material, a water pipe and a gas pipe; a construction material such as a pillar, a flooring material, a decorative plate, a window frame and a heat insulating material; furniture such as a bookshelf, a desk and a chair; an industrial robot; a household robot; a hot melt adhesive; a filament and a support agent for a lamination type 3D printer; a binder resin for a recording material such as paint, an ink and toner; a packaging material such as a film and a tape; a resin container such as a PET bottle; household goods such as an eyeglass frame, a trash box and a sharp pencil case; and so on.

### EXAMPLE

Hereinafter, examples of the present invention are described. Note that, the present invention is not limited to these examples.

[Cellulose Fibers (A)]

As the cellulose fibers (A) which are the raw materials used in the example, generally-available nadelholz bleached kraft pulp (A-1, hereinafter simply referred to as the “cellulose fibers (A-1)”) or modified cellulose fibers (A-2) obtained in the following manner were used.

### Production Example 1A

100 parts by mass of the cellulose fibers (A-1), 400 parts by mass of water, and 150 parts by mass of N-methylpyrrolidone (hereinafter referred to as NMP) were added into a container, water was distilled off by reduced-pressure dehydration, 19.9 parts by mass of hexadecenyl succinic anhydride was put in, and a reaction was carried out at 80° C. for 4 hours. After the reaction, NMP was distilled off by reduced-pressure distilling-, and the modified cellulose fibers (A-2) were obtained. A degree of substitution (DS) of a polybasic acid anhydride calculated as follows was 0.051.

<Calculation of Degree of Substitution (DS) of Polybasic Acid Anhydride of Cellulose Fibers (A-2)>

In the calculation of the degree of substitution DS of the cellulose fibers (A-2), the unreacted polybasic acid anhydride and the hydrolyzate thereof contained in the obtained modified cellulose fibers were removed by washing, then drying and solidification were performed, and the degree of substitution DS of the cellulose fibers (A-2) was calculated according to the following formula.

DS=(a/b)/(c/d)

a: (dry mass after washing of cellulose fibers (A-2) after modification)−(dry mass of cellulose fibers (A-1) used for modification)
b: molecular weight of polybasic acid anhydride
c: dry mass of cellulose fibers (A-1) used for modification
d: molecular weight of glucose unit constituting cellulose (molecular weight 162)

### Acrylic Resin and/or Styrene Acrylic Resin (B)

### Production Example 1B

500 parts by mass of propylene glycol monomethyl ether acetate was added into a reaction container equipped with a stirrer, a thermometer, and a reflux condenser, and the temperature was raised while stirring until the internal temperature reached 145° C. It took 4 hours to add 350 parts by mass of methyl methacrylate, 50 parts by mass of cyclohexyl methacrylate, and 100 parts by mass of butyl acrylate as acrylic monomers, and 40 parts by mass of di-t-butyl peroxide as a polymerization initiator. After completion of the addition, thermal insulation was performed at an internal temperature of 145° C. for 1 hour, then unreacted substances and the solvent in the system were removed, and an acrylic resin and/or a styrene acrylic resin (B-1) was obtained. Note that, the dissolution amount in water, the glass transition temperature, the acid value, and the number average molecular weight of the resin (B-1) are shown in Table 1.

### Production Example 2B

500 parts by mass of propylene glycol monomethyl ether acetate was added into a reaction container equipped with a stirrer, a thermometer, and a reflux condenser, and the temperature was raised while stirring until the internal temperature reached 140° C. It took 3 hours to add 150 parts by mass of butyl acrylate as an acrylic monomer, 350 parts by mass of styrene as a styrene monomer, and 2.5 parts by mass of di-t-butyl peroxide as a polymerization initiator. After completion of the addition, thermal insulation was performed at an internal temperature of 145° C. for 2 hours, then unreacted substances and the solvent in the system were removed, and an acrylic resin and/or a styrene acrylic resin (B-2) was obtained. Note that, the dissolution amount in water, the glass transition temperature, the acid value, and the number average molecular weight of the resin (B-2) are shown in Table 1.

### Production Example 3B

500 parts by mass of propylene glycol monomethyl ether acetate was added into a reaction container equipped with a stirrer, a thermometer, and a reflux condenser, and the temperature was raised while stirring until the internal temperature reached 140° C. It took 3 hours to add 150 parts by mass of acrylic acid as an acrylic monomer, 100 parts by mass of styrene as a styrene monomer, 250 parts by mass of α-methylstyrene, and 20 parts by mass of di-t-butyl peroxide as a polymerization initiator. After completion of the addition, thermal insulation was performed at an internal temperature of 145° C. for 2 hours, then unreacted substances and the solvent in the system were removed, and an acrylic resin and/or a styrene acrylic resin (B-3) was obtained. Note that, the dissolution amount in water, the glass transition temperature, the acid value, and the number average molecular weight of the resin (B-3) are shown in Table 1.

### Production Examples 4B to 5B

Acrylic resins and/or styrene acrylic resins (B-4 to B-5) were obtained according to the method described in Production Example 3B, except that the type and the addition amount of the monomers were changed as shown in Table 1. The dissolution amount in water, the glass transition temperature, the acid value, and the number average molecular weight of the resins (B-4 to B-5) are shown in Table 1.

### Production Example 6B

500 parts by mass of propylene glycol monomethyl ether acetate was added into a reaction container equipped with a stirrer, a thermometer, and a reflux condenser, and the temperature was raised while stirring until the internal temperature reached 140° C. It took 3 hours to add 150 parts by mass of 2-ethylhexyl acrylate and 100 parts by mass of acrylic acid as acrylic monomers, 250 parts by mass of styrene as a styrene monomer, and 10 parts by mass of di-t-butyl peroxide as a polymerization initiator. After completion of the addition, thermal insulation was performed at an internal temperature of 145° C. for 2 hours, then unreacted substances and the solvent in the system were removed, and an acrylic resin and/or a styrene acrylic resin (B-6) was obtained. Note that, the dissolution amount in water, the glass transition temperature, the acid value, and the number average molecular weight of the resin (B-6) are shown in Table 1.

### Production Example 7B

An acrylic resin and/or a styrene acrylic resin (B-7) was obtained according to the method described in Production Example 1B, except that the type and the addition amount of the monomers were changed as shown in Table 1. The dissolution amount in water, the glass transition temperature, the acid value, and the number average molecular weight of the resins (B-7) are shown in Table 1.

### Production Example 8B

500 parts by mass of xylene and 100 parts by mass of polypropylene (weight average molecular weight 45,000, melt mass flow rate 2000 g/10 min (230° C., 2.16 kg)) were added into a reaction container equipped with a stirrer, a thermometer, and a reflux condenser, the temperature was raised while stirring until the internal temperature reached 140° C., and polypropylene was melted. It took 4 hours to add 50 parts by mass of butyl acrylate and 25 parts by mass of methacrylic acid as acrylic monomers, 325 parts by mass of styrene as a styrene monomer, and 25 parts by mass of di-t-butyl peroxide as a polymerization initiator. After completion of the addition, thermal insulation was performed at an internal temperature of 140° C. for 1 hour, then unreacted substances and the solvent in the system were removed, and an acrylic resin and/or a styrene acrylic resin (B-8) was obtained. The dissolution amount in water, the glass transition temperature, the acid value, and the number average molecular weight of the resin (B-8) are shown in Table 1.

### Production Example 1b

500 parts by mass of ethyl acetate was added into a reaction container equipped with a stirrer, a thermometer, and a reflux condenser, and the temperature was raised while stirring until the internal temperature reached 70° C. It took 1 hour to add 500 parts by mass of butyl acrylate as an acrylic monomer and 0.5 part by mass of dimethyl 2,2′-azobis(2-methylpropionate) as a polymerization initiator. After completion of the addition, thermal insulation was performed at an internal temperature of 80° C. for 5 hours, then unreacted substances and the solvent in the system were removed, and an acrylic resin and/or a styrene acrylic resin (BH-1) was obtained. Note that, the dissolution amount in water, the glass transition temperature, the acid value, and the number average molecular weight of the resin (BH-1) are shown in Table 2.

### Production Example 2b

250 parts by mass of propylene glycol monomethyl ether was added into a reaction container equipped with a stirrer, a thermometer, and a reflux condenser, and the temperature was raised while stirring until the internal temperature reached 100° C. It took 4 hours to add 500 parts by mass of propylene glycol monomethyl ether, 300 parts by mass of methyl methacrylate, 100 parts by mass of 2-ethylhexyl acrylate, and 200 parts by mass of a 50% acrylamide aqueous solution as acrylic monomers, and 3 parts by mass of 2,2′-azobis(2-methylbutyronitrile) as a polymerization initiator. After completion of the addition, thermal insulation was performed at an internal temperature of 100° C. for 1 hour, then unreacted substances and the solvent in the system were removed, and an acrylic resin and/or a styrene acrylic resin (BH-2) was obtained. Note that, the dissolution amount in water, the glass transition temperature, the acid value, and the number average molecular weight of the resin (BH-2) are shown in Table 2.

<Dissolution Amount in Water of Acrylic Resin and/or Styrene Acrylic Resin (B)>

The acrylic resins and/or the styrene acrylic resins (B-1 to BH-2) obtained in Production Examples 1B to 2b were crushed, 10 g of the resin that passed through a sieve having a mesh size of 600 μm was precisely weighed as the mass before dissolution, 100 g of water was added, and stirring was performed at 25° C. for 3 hours. The stirred liquid was filtered by a filter paper, a residue was dried at 120° C. for 2 hours and then precisely weighed as the mass of residue, and the dissolution amount was calculated according to the following formula.

Dissolution amount (g)=(mass before dissolution)−(mass of residue)

<Glass Transition Temperature (Tg) of Acrylic Resin and/or Styrene Acrylic Resin (B)>

The obtained acrylic resins and/or styrene acrylic resins (B-1 to BH-2) were heated to 150° C. using a differential scanning calorimeter (manufactured by Seiko Instruments Co., Ltd.: DSC-6200), left at that temperature for 10 minutes, then cooled to 0° C. at a temperature drop rate of 10° C./min, and left at that temperature for 10 minutes, then measurement was performed at a temperature rise rate of 10° C./min, and a temperature at an intersection between an extended line of the baseline below the glass transition temperature and a tangent line indicating the maximum slope from the rising portion of the peak to the peak point at this time was set as a glass transition temperature (Tg).

<Acid Value of Acrylic Resin and/or Styrene Acrylic Resin (B)>

The acid value of the obtained acrylic resins and/or styrene acrylic resins (B-1 to BH-2) was measured by an acid-base titration method using potassium hydroxide in accordance with JIS K0070.

<Number Average Molecular Weight (Mn) of Acrylic Resin and/or Styrene Acrylic Resin (B)>

The number average molecular weight (Mn) of the obtained acrylic resins and/or styrene acrylic resins (B-1 to BH-2) was measured by the following device and conditions and was calculated as the molecular weight in terms of standard polystyrene.

Device: Gel Permeation Chromatography (HLC-8320GPC) manufactured by Tosoh Corporation

Column: TSKgel SuperMultipore HZ-H and TSKgel SuperMultipore HZ-M are sequentially connected in series for use.

Developing solvent: tetrahydrofuran

Detector: RI (differential refractive index) detector

Sample: tetrahydrofuran 10 mL solution of 0.01 g of the acrylic resins and/or the styrene acrylic resins (B-1 to BH-2)

TABLE 1

| | | Composition of raw material | | | | | | | | | | | | | |
|---|---|---|---|---|---|---|---|---|---|---|---|---|---|---|---|
| | | | | | | | | | | | | Resin properties | | | |
| | | | | | | | | | Styrene | | | Dissolution | | | |
| Production | | Acrylic monomer | | | | | | | monomer | | | amount in | | Acid | |
| Example | Resin | MMA | CHMA | BA | 2EHA | AA | MAA | AAm | ST | αMST | PP | water | Tg | value | Mn |
| 1B | B-1 | 70 | 10 | 20 | | | | | | | | 0.10 | 48 | 0 | 3200 |
| 2B | B-2 | | | 30 | | | | | 70 | | | 0.12 | 51 | 0 | 11300 |
| 3B | B-3 | | | | | 30 | | | 20 | 50 | | 0.31 | 138 | 249 | 4000 |
| 4B | B-4 | 70 | | 20 | | | 10 | | | | | 0.21 | 66 | 78 | 5600 |
| 5B | B-5 | 10 | | | | | 5 | | 85 | | | 0.10 | 92 | 16 | 5400 |
| 6B | B-6 | | | | 30 | 20 | | | 50 | | | 0.13 | 83 | 164 | 6300 |
| 7B | B-7 | 70 | | | | 10 | | | 20 | | | 0.31 | 86 | 78 | 3900 |
| 8B | B-8 | | | 10 | | | 5 | | 65 | | 20 | 0.19 | 72 | 23 | 3800 |

TABLE 2

| | | Composition of raw material | | | | | | | | | | | | | |
|---|---|---|---|---|---|---|---|---|---|---|---|---|---|---|---|
| | | | | | | | | | | | | Resin properties | | | |
| | | | | | | | | | Styrene | | | Dissolution | | | |
| Production | | Acrylic monomer | | | | | | | monomer | | | amount in | | Acid | |
| Example | Resin | MMA | CHMA | BA | 2EHA | AA | MAA | AAm | ST | αMST | PP | water | Tg | value | Mn |
| 1b | BH-1 | | | 100 | | | | | | | | 0.32 | −36 | 0 | 65000 |
| 2b | BH-2 | 60 | | | 20 | | | 20 | | | | 4.10 | 56 | 0 | 22000 |

The abbreviations in Tables 1 and 2 are as follows.
MMA: methyl methacrylate, CHMA: cyclohexyl methacrylate, BA: butyl acrylate
2EHA: 2-ethylhexyl acrylate, AA: acrylic acid, MAA: methacrylic acid, AAm: acrylamide
ST: styrene, αMST: α-methylstyrene, PP: polypropylene (weight average molecular weight 45,000, melt mass flow rate 2000 g/10 min (230° C., 2.16 kg))

### Example 1

### [Production of Polypropylene Resin Composition]

67 parts by mass of the cellulose fibers (A-1) serving as the cellulose fibers (A), 268 parts by mass of water, 33 parts by mass of the acrylic resin and/or the styrene acrylic resin (B-1), and 134 parts by mass of propylene glycol monomethyl ether were put into a container and mixed at 70° C., then the temperature was raised to 130° C., the water and the propylene glycol monomethyl ether were distilled off under reduced pressure, and a cellulose fiber composition containing the cellulose fibers (A-1) and the acrylic resin and/or the styrene acrylic resin (B-1) was obtained. Next, 7.5 parts by mass of water was added to 100 parts by mass of the cellulose fiber composition and mixed, and thereby a water-containing cellulose fiber composition was obtained. Subsequently, a resin composition was obtained by kneading 107.5 parts by mass of the water-containing cellulose fiber composition and 233 parts by mass of a polypropylene resin (“Prime Polypro (registered trademark) J108M” manufactured by Prime Polymer Co., Ltd., melting point 165° C.) serving as the thermoplastic resin (C) at 170° C. while reducing the pressure by a twin-screw extruder (shaft diameter 15 mm, L/D=45, manufactured by Technobel Co., Ltd.). The water content in the obtained resin composition was 0.2%.

### Examples 2 to 9 and 11

Resin compositions were obtained according to the method described in Example 1, except that the type and the addition amount of the cellulose fibers (A), the type and the addition amount of the acrylic resin and/or the styrene acrylic resin (B), and the addition amount of the thermoplastic resin (C) were changed as shown in Table 4.

### Example 10

71 parts by mass of the modified cellulose fibers (A-2) serving as the cellulose fibers (A), 29 parts by mass of the acrylic resin and/or the styrene acrylic resin (B-7), and 7.5 parts by mass of water were added into a container and mixed, and thereby a water-containing cellulose fiber composition was obtained. Subsequently, a resin composition was obtained by kneading 107.5 parts by mass of the water-containing cellulose fiber composition and 194 parts by mass of the polypropylene resin (“Prime Polypro J108M” manufactured by Prime Polymer Co., Ltd., melting point 165° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.4%.

### Comparative Example 1

100 parts by mass of the cellulose fibers (A-1) serving as the cellulose fibers (A) and 7.5 parts by mass of water were added into a container and mixed, and thereby water-containing cellulose fibers were obtained. Subsequently, a resin composition was obtained by kneading 107.5 parts by mass of the water-containing cellulose fibers and 400 parts by mass of the polypropylene resin (“Prime Polypro J108M” manufactured by Prime Polymer Co., Ltd., melting point 165° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.5%.

### Comparative Example 2

100 parts by mass of the acrylic resin and/or the styrene acrylic resin (B-1) and 7.5 parts by mass of water were added into a container and mixed, and thereby a water-containing acrylic resin was obtained. Subsequently, a resin composition was obtained by kneading 107.5 parts by mass of the water-containing acrylic resin and 233 parts by mass of the polypropylene resin (“Prime Polypro J108M” manufactured by Prime Polymer Co., Ltd., melting point 165° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.3%.

### Comparative Example 3

67 parts by mass of the cellulose fibers (A-1) serving as the cellulose fibers (A), 268 parts by mass of water, 33 parts by mass of maleic anhydride-modified polypropylene (Toyotac PMA H-1000P, manufactured by Toyobo Co., Ltd.), and 134 parts by mass of propylene glycol monomethyl ether were put into a container and mixed at 70° C., then the temperature was raised to 130° C., the water and the propylene glycol monomethyl ether were distilled off under reduced pressure, and a cellulose fiber composition containing the cellulose fibers (A-1) and the maleic acid-modified polypropylene was obtained. Next, 7.5 parts by mass of water was added to 100 parts by mass of the cellulose fiber composition and mixed, and thereby a water-containing cellulose fiber composition was obtained. Subsequently, a resin composition was obtained by kneading 107.5 parts by mass of the water-containing cellulose fiber composition and 233 parts by mass of the polypropylene resin (“Prime Polypro (registered trademark) J108M” manufactured by Prime Polymer Co., Ltd., melting point 165° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.3%.

### Comparative Examples 4 to 7

Resin compositions were obtained according to the method described in Example 1, except that the addition amount of the cellulose fibers (A), the type and the addition amount of the acrylic resin and/or the styrene acrylic resin (B), the addition amount of water, and the addition amount of the thermoplastic resin (C) were changed as shown in Table 4.

### Example 12

### [Production of Polyethylene Resin Composition]

67 parts by mass of the cellulose fibers (A-1) serving as the cellulose fibers (A), 268 parts by mass of water, 33 parts by mass of the acrylic resin and/or the styrene acrylic resin (B-7), and 134 parts by mass of propylene glycol monomethyl ether were put into a container and mixed at 70° C., then the temperature was raised to 130° C., the water and the propylene glycol monomethyl ether were distilled off under reduced pressure, and a cellulose fiber composition containing the cellulose fibers (A-1) and the acrylic resin and/or the styrene acrylic resin (B-7) was obtained. Next, 7.5 parts by mass of water was added to 100 parts by mass of the cellulose fiber composition and mixed, and thereby a water-containing cellulose fiber composition was obtained. Subsequently, a resin composition was obtained by kneading 107.5 parts by mass of the water-containing cellulose fiber composition and 233 parts by mass of a high-density polyethylene resin (“Suntec (registered trademark) J320” manufactured by Asahi Kasei Co., Ltd., melting point 130° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.3%.

### Comparative Example 8

100 parts by mass of the cellulose fibers (A-1) serving as the cellulose fibers (A) and 7.5 parts by mass of water were added into a container and mixed, and thereby water-containing cellulose fibers were obtained. Subsequently, a resin composition was obtained by kneading 107.5 parts by mass of the water-containing cellulose fibers and 400 parts by mass of the high-density polyethylene resin (“Suntec J320” manufactured by Asahi Kasei Co., Ltd., melting point 130° C.) serving as the thermoplastic resin (C) at 170° C. while reducing the pressure by the twin-screw extruder (shaft diameter 15 mm, L/D=45, manufactured by Technobel Co., Ltd.). The water content in the obtained resin composition was 0.4%.

<Evaluation of Resin Composition>

### (Calculation of Water Content)

5 g of the resin compositions obtained in Examples 1 to 12 and Comparative Examples 1 to 8 was taken, and the mass before drying was precisely weighed. Then, after being dried by an electric dryer at 150° C. for 30 minutes, the resin composition was cooled for 15 minutes in a desiccator and then precisely weighed as the mass after drying, and the water content was calculated according to the following formula. The results are shown in Tables 4 and 5.

Water content (%)=(mass before drying−mass after drying)/(mass before drying)×100

(Injection Molding, Measurement of Bending Property)

The obtained resin composition was molded using an injection molding machine into a bar-shaped test piece described in JIS standard K7171, a bending elastic modulus was measured by a universal testing machine “Tensilon (registered trademark) RTM-50” manufactured by Orientec Co., Ltd. in accordance with JIS K7171, and the results of comparing, as an index, an improvement rate of the bending elastic modulus with respect to the resin alone are shown in Tables 4 and 5.

Elastic modulus [index]=(bending elastic modulus of Example and Comparative Example)/(bending elastic modulus of resin alone)

(Evaluation Method of Dispersibility)

The obtained resin composition was made into a film (thickness 0.2 mm) using a hot press molding machine, and the number of aggregates having a size of 1 mm or greater existing in a circle having a diameter of about 8 cm was evaluated according to the following criteria. The results are shown in Tables 4 and 5.

TABLE 3

| Evaluation | Number of aggregates |
|---|---|
| 1 | 1 or less |
| 2 | 2 to 4 |
| 3 | 5 to 10 |
| 4 | 11 to 20 |
| 5 | 21 or more |

When the dispersibility evaluation is level 5, it is indicated that the dispersibility is insufficient.

TABLE 4

| | Water-containing cellulose fiber composition | | | | | | | | | | | |
|---|---|---|---|---|---|---|---|---|---|---|---|---|
| | Cellulose fiber composition (A) + (B) | | | | | | | | | | | |
| | | | Acrylic resin | | | | | | | | | |
| | Cellulose | | and/or styrene | | | | Thermoplastic | | | Resin composition | | |
| | fibers (A) | | acrylic resin (B) | | | Water | resin (C) | | | Water | | |
| | | part by | | part by | part by | part by | | part by | [(A) + | content | Elastic | |
| | | mass | | mass | mass | mass | Type | mass | (B)]/(C) | (%) | modulus | Dispersibility |
| Example 1 | A-1 | 67 | B-1 | 33 | 100 | 7.5 | PP | 233 | 30/70 | 0.2 | 1.7 | 4 |
| Example 2 | A-1 | 80 | B-1 | 20 | 100 | 7.5 | PP | 233 | 30/70 | 0.2 | 1.7 | 4 |
| Example 3 | A-1 | 50 | B-1 | 50 | 100 | 7.5 | PP | 213 | 32/68 | 0.3 | 1.7 | 4 |
| Example 4 | A-1 | 67 | B-2 | 33 | 100 | 7.5 | PP | 233 | 30/70 | 0.5 | 1.8 | 4 |
| Example 5 | A-1 | 67 | B-3 | 33 | 100 | 7.5 | PP | 233 | 30/70 | 0.4 | 1.7 | 4 |
| Example 6 | A-1 | 67 | B-4 | 33 | 100 | 7.5 | PP | 233 | 30/70 | 0.3 | 1.8 | 3 |
| Example 7 | A-1 | 67 | B-5 | 33 | 100 | 7.5 | PP | 233 | 30/70 | 0.3 | 1.9 | 2 |
| Example 8 | A-1 | 67 | B-6 | 33 | 100 | 7.5 | PP | 233 | 30/70 | 0.5 | 1.9 | 2 |
| Example 9 | A-1 | 67 | B-7 | 33 | 100 | 7.5 | PP | 233 | 30/70 | 0.3 | 2.0 | 2 |
| Example 10 | A-2 | 71 | B-7 | 29 | 100 | 7.5 | PP | 194 | 30/70 | 0.4 | 1.9 | 1 |
| Example 11 | A-1 | 67 | B-8 | 29 | 100 | 7.5 | PP | 233 | 30/70 | 0.2 | 1.9 | 1 |
| Comparative | A-1 | 100 | — | 0 | 100 | 7.5 | PP | 400 | 20/80 | 0.5 | 1.4 | 5 |
| Example 1 | | | | | | | | | | | | |
| Comparative | — | — | B-1 | 100 | 100 | 7.5 | PP | 233 | 30/70 | 0.3 | 1.1 | — |
| Example 2 | | | | | | | | | | | | |
| Comparative | A-1 | 67 | (*1) | 33 | 100 | 7.5 | PP | 233 | 30/70 | 0.3 | 1.5 | 5 |
| Example 3 | | | | | | | | | | | | |
| Comparative | A-1 | 67 | BH-1 | 33 | 100 | 7.5 | PP | 233 | 30/70 | 0.3 | 0.8 | 5 |
| Example 4 | | | | | | | | | | | | |
| Comparative | A-1 | 67 | BH-2 | 33 | 100 | 7.5 | PP | 233 | 30/70 | 0.2 | 1.4 | 5 |
| Example 5 | | | | | | | | | | | | |
| Comparative | A-1 | 91 | B-1 | 9 | 100 | 7.5 | PP | 355 | 30/70 | 0.4 | 1.4 | 5 |
| Example 6 | | | | | | | | | | | | |
| Comparative | A-1 | 67 | B-1 | 33 | 100 | 0 | PP | 233 | 30/70 | 0 | 1.4 | 5 |
| Example 7 | | | | | | | | | | | | |

In Table 4, (*1) represents maleic anhydride-modified polypropylene (Toyotac PMA H-1000P, manufactured by Toyobo Co., Ltd.).

TABLE 5

| | Water-containing cellulose fiber composition | | | | | | | | | | | |
|---|---|---|---|---|---|---|---|---|---|---|---|---|
| | Cellulose fiber composition (A) + (B) | | | | | | | | | | | |
| | | | Acrylic resin | | | | | | | | | |
| | Cellulose | | and/or styrene | | | | Thermoplastic | | | Resin composition | | |
| | fiber (A) | | acrylic resin (B) | | | Water | resin (C) | | | Water | | |
| | | part by | | part by | part by | part by | | parts by | [(A) + | content | Elastic | |
| | | mass | | mass | mass | mass | Type | mass | (B)]/(C) | (%) | modulus | Dispersibility |
| Example 12 | A-1 | 67 | B-7 | 33 | 100 | 7.5 | HDPE | 233 | 30/70 | 0.3 | 2.8 | 2 |
| Comparative | A-1 | 100 | — | 0 | 100 | 7.5 | HDPE | 400 | 20/80 | 0.4 | 1.7 | 5 |
| Example 8 | | | | | | | | | | | | |

The abbreviation in the table is as follows.

HDPE: High-density polyethylene resin (“Suntec J320” manufactured by Asahi Kasei Co., Ltd., melting point 130° C.)

From the results of Example 1 and Comparative Example 7, it can be seen that a resin composition obtained by the production method of kneading the water-containing cellulose fiber composition and the thermoplastic resin specified in the present invention has excellent mechanical strength and dispersibility as compared with a resin composition obtained by a production method of kneading a water-free cellulose fiber composition and a thermoplastic resin.

From the results of Examples 1 to 12 and Comparative Examples 1 to 6 and 8, it can be seen that the resin composition specified in the present invention, which is obtained by kneading the cellulose fibers and the acrylic resin and/or the styrene acrylic resin with the thermoplastic resin, has excellent mechanical strength and dispersibility.

From the results of Examples 1 to 5 and Examples 6 to 11, it can be seen that a resin composition obtained by kneading an acrylic resin and/or a styrene acrylic resin containing an acrylic acid and/or methacrylic acid and having an acid value of 10 to 200 mgKOH/g, cellulose fibers, and a thermoplastic resin has excellent mechanical strength and dispersibility as compared with a resin composition obtained by kneading an acrylic resin and/or a styrene acrylic resin having an acid value smaller than 10 mgKOH/g or greater than 200 mgKOH/g, cellulose fibers, and a thermoplastic resin.

What is claimed is:

1. A resin composition production method, comprising a step in which
a cellulose fiber composition containing 5 to 45 parts by mass of water with respect to a total of 100 parts by mass of cellulose fibers (A) and an acrylic resin and/or a styrene acrylic resin (B)
is kneaded with a thermoplastic resin (C), and
water is removed until the water content after kneading falls to 1% or less, wherein
20 parts by mass or more and 200 parts by mass or less of the acrylic resin and/or the styrene acrylic resin (B) is blended with respect to 100 parts by mass of the cellulose fibers (A); and
the dissolution amount of the acrylic resin and/or the styrene acrylic resin (B) in 100 g of water at 25° C. is less than 1 g, and the glass transition temperature of the acrylic resin and/or the styrene acrylic resin (B) is 40 to 150° C.

2. The resin composition production method according to claim 1, wherein the acrylic resin and/or the styrene acrylic resin (B) is a polymer of a monomer containing an acrylic acid and/or a methacrylic acid and has an acid value of 10 to 200 mgKOH/g.

3. The resin composition production method according to claim 1, wherein the mass ratio of the total of the cellulose fibers (A) and the acrylic resin and/or the styrene acrylic resin (B) to the thermoplastic resin (C) is [(A)+(B)]/(C)=1/99 to 60/40.

4. The resin composition production method according to claim 1, wherein the thermoplastic resin (C) is a polyolefin.

5. A resin composition containing:
cellulose fibers (A),
an acrylic resin and/or a styrene acrylic resin (B), and
a thermoplastic resin (C), wherein
the resin composition contains, with respect to 100 parts by mass of the cellulose fibers (A), 20 parts by mass or more and 200 parts by mass or less of the acrylic resin and/or the styrene acrylic resin (B), and
the dissolution amount of the acrylic resin and/or the styrene acrylic resin (B) in 100 g of water at 25° C. is less than 1 g, and the glass transition temperature of the acrylic resin and/or the styrene acrylic resin (B) is 40 to 150° C.

6. The resin composition according to claim 5, wherein the acrylic resin and/or the styrene acrylic resin (B) is a polymer of a monomer containing an acrylic acid and/or a methacrylic acid and has an acid value of 10 to 200 mgKOH/g.

7. The resin composition according to claim 5, wherein the mass ratio of the total of the cellulose fibers (A) and the acrylic resin and/or the styrene acrylic resin (B) to the thermoplastic resin (C) is [(A)+(B)]/(C)=1/99 to 60/40.

8. The resin composition according to claim 5, wherein the thermoplastic resin (C) is a polyolefin.
